(19) United States
(12) Patent Application Publication
(10) Pub. No.: US 2024/0332975 A1
(43) Pub. Date: Oct. 3, 2024

(54) POWER SUPPLY APPARATUS AND METHOD FOR CONTROLLING POWER SUPPLY APPARATUS

(71) Applicant: Panasonic Intellectual Property Management Co., Ltd., Osaka (JP)

(72) Inventor: Atsushi IISAKA, Kanagawa (JP)

(21) Appl. No.: 18/420,480

(22) Filed: Jan. 23, 2024

(30) Foreign Application Priority Data
Mar. 30, 2023 (JP) 2023-054511

(51) Int. Cl. H02J 3/32; B60L 53/20; B60L 58/10; G06F 1/26; H02J 7/00; H02J 7/04

(52) U.S. Cl. CPC H02J 3/322; B60L 53/20; B60L 58/10; G06F 1/263; H02J 7/0047; H02J 7/0068; H02J 7/04; B60L 2240/549

(57) ABSTRACT

A power supply apparatus includes: an inlet to which first AC power is input; a bidirectional charger capable of performing power conversion between both AC power and DC power; a battery that stores DC power; a V2L outlet capable of outputting second AC power; a current sensor that detects an amount of a current flowing toward the V2L outlet when the second AC power is output from the V2L outlet when the first AC power is branched and supplied to the bidirectional charger and the V2L outlet; a memory; and a hardware processor coupled to the memory. The hardware processor controls an amount of a current flowing toward the bidirectional charger in such a manner that a total current amount of an amount of a current flowing toward the V2L outlet and an amount of a current flowing toward the bidirectional charger falls within a predetermined allowable current value.

### CROSS-REFERENCE TO RELATED APPLICATIONS

This application is based upon and claims the benefit of priority from Japanese Patent Application No. 2023-054511, filed on Mar. 30, 2023, the entire contents of which are incorporated herein by reference.

### FIELD

The present disclosure relates to a power supply apparatus and a method for controlling the power supply apparatus.

### BACKGROUND

Conventionally, in an EV vehicle or the like, a vehicle to load (V2L) is known for the purpose of supplying electric power of an in-vehicle power storage device to an external device such as a home appliance.

V2L is, for example, a power supply apparatus that performs DC/AC conversion of power from a power storage device configured as an in-vehicle battery to supply power to an external load such as a home appliance, and includes a charger that converts AC power supplied from an external connector into DC power to charge the power storage device, an inverter that performs DC/AC conversion of stored power of the power storage device to supply AC power to the external load, and an ECU that controls the charger and the inverter.

A related technique is disclosed in JP 2014-204600 A.

In the power supply apparatus having the above configuration, the AC power is converted into the DC power and stored in the power storage device, and the power stored in the power storage device is again converted from the DC power into the AC power and supplied to the external load, so that the power loss increases.

Further, it is necessary to provide a charger and an inverter, and the installation area or the installation volume has been increased.

An object of the present disclosure is to provide a power supply apparatus and a method for controlling the power supply apparatus capable of reducing power loss in the power supply apparatus, reducing an installation area or an installation volume, reducing an influence of a capacity of an on-vehicle storage battery and a size of a vehicle, and expanding an application range.

### SUMMARY

A power supply apparatus according to the present disclosure includes an inlet, a bidirectional charger, a battery, a V2L outlet, a current sensor, a memory, and a hardware processor. First AC power is input to the inlet. The bidirectional charger is capable of performing power conversion between both AC power and DC power. The battery stores DC power. The V2L outlet is capable of outputting second AC power. The current sensor detects an amount of a current flowing toward the V2L outlet when the second AC power is output from the V2L outlet when the first AC power is branched and supplied to the bidirectional charger and the V2L outlet. The hardware processor is coupled to the memory. The hardware processor controls an amount of a current flowing toward the bidirectional charger in such a manner that a total current amount of an amount of a current flowing toward the V2L outlet and an amount of a current flowing toward the bidirectional charger falls within a predetermined allowable current value.

### BRIEF DESCRIPTION OF THE DRAWINGS

FIG. 1 is a schematic configuration block diagram of a power supply system including a power supply apparatus according to a first embodiment;

FIG. 2 is a processing flowchart of the first embodiment;

FIG. 3 is a schematic configuration block diagram of a power supply system including a power supply apparatus according to a second embodiment; and

FIG. 4 is a processing flowchart of the second embodiment.

### DETAILED DESCRIPTION

Hereinafter, embodiments of the present invention will be described with reference to the drawings.

### First Embodiment

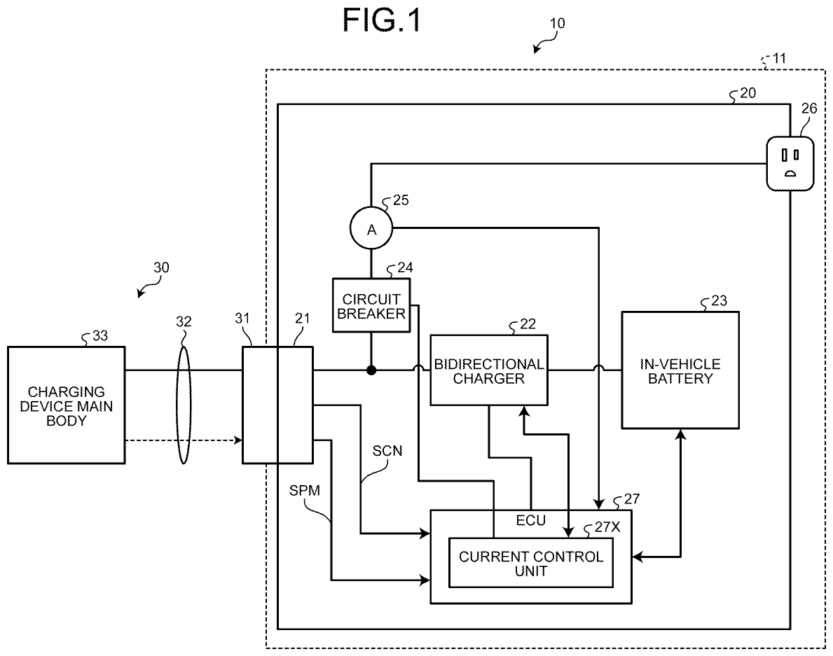

FIG. 1 is a schematic configuration block diagram of a power supply system including a power supply apparatus according to a first embodiment.

As illustrated in FIG. 1, a power supply system 10 of the first embodiment includes a power supply apparatus 20 provided in an EV vehicle 11 and an external charging device 30.

The power supply apparatus 20 includes a charging inlet 21, a bidirectional charger 22, an in-vehicle battery 23, a circuit breaker 24, a current sensor 25, a V2L outlet 26, and an ECU 27.

Further, the external charging device 30 includes a charging connector 31, a charging cable 32, and a charging device main body 33.

In the above configuration, the charging connector 31 of the external charging device 30 is electrically connected to the charging inlet 21 at the time of charging, and charging power and a power management signal SPM are input from the charging device main body 33 via the charging connector 31 and the charging cable 32.

Then, the charging inlet 21 outputs the input charging power to the bidirectional charger, and outputs the power management signal SPM to the ECU 27.

Further, the charging inlet 21 outputs a connection state signal SCN indicating a connection state (normal connection state, connection failure state, or the like) of the charging connector 31 to the ECU 27.

When the charging connector 31 is connected to the charging inlet 21, the bidirectional charger 22 converts the power from the charging inlet 21 to charge the in-vehicle battery 23.

Further, when the charging connector 31 is not connected to the charging inlet 21 and a load is connected to the V2L outlet 26, the bidirectional charger 22 converts the stored power from the in-vehicle battery 23 and supplies the converted power to the load.

The in-vehicle battery 23 receives charging power from the bidirectional charger 22 or a power generating motor generator (not illustrated) and stores the charging power. Further, the in-vehicle battery 23 outputs the stored power to the bidirectional charger 22, and outputs the stored power from the V2L outlet 26, or outputs the stored power to an in-vehicle device, a driving motor generator, or the like (not illustrated).

The circuit breaker 24 cuts off the power supply path when overvoltage or overcurrent is detected in the power supply path to the V2L outlet 26.

The current sensor 25 detects the amount of current flowing through the V2L outlet 26 in the power supply path to the V2L outlet 26 and notifies the ECU 27 of the detected amount.

The V2L outlet can supply 100 V single-phase AC power, and can be connected to a home appliance or the like.

The ECU 27 controls the entire power supply apparatus 20. Further, the ECU 27 also includes a current control unit 27X that controls the power output from the V2L outlet 26 and the amount of current from the external charging device taken in for charging the in-vehicle battery 23 in the bidirectional charger 22.

Next, prior to describing the operation of the embodiment, conventional problems will be described.

Conventionally, in a vehicle including a V2L outlet, the following configuration is considered as a configuration for using V2L.

(1) A configuration in which a charger is provided between the charging inlet and the in-vehicle battery, and an inverter is further provided between the in-vehicle battery and the V2L outlet as another system.

(2) A configuration in which a bidirectional charger is provided between the charging inlet and the in-vehicle battery, the in-vehicle battery is connected to an input/output terminal functioning as one output terminal of the bidirectional charger, and the V2L outlet is connected to the other output terminal.

(3) A configuration in which a bidirectional charger is provided between the charging inlet and the in-vehicle battery, and a current flow path provided between the charging inlet and the bidirectional charger is branched to provide the V2L outlet.

In the configuration of (1) described above, when the V2L outlet is to be used during charging by an external AC power supply of the in-vehicle battery by the in-vehicle charger, the AC power is converted into the DC power by the charger, and the converted DC power is converted from the DC power into the AC power again by the inverter and output to the V2L outlet.

Therefore, there is a problem that both the charger and the inverter are required, power conversion needs to be performed twice, conversion loss occurs, and the power loss is large.

Further, in the configuration of the above (2), there is a problem that the V2L outlet cannot be used during charging by the external AC power supply of the in-vehicle battery in the in-vehicle charger.

Furthermore, in the configuration of (3) described above, although the V2L outlet can be used, depending on the load connected to the V2L outlet, the allowable current on the external charging device main body side may be exceeded and the load may be cut off by a breaker.

Therefore, an object of the power supply apparatus of the present embodiment is to enable use of the V2L outlet during charging of the in-vehicle battery while reducing the power conversion loss with a simplified device configuration.

Next, an operation of the embodiment will be described.

First, a charging operation by the external charging device 30 will be described.

When the charging connector 31 is connected to the charging inlet 21, the charging inlet 21 outputs the input power management signal SPM from the external charging device 30 to the ECU 27. In this case, the power management signal SPM also includes information of an allowable current value of the charging cable 32.

In parallel with this, the charging inlet 21 outputs the connection state signal SCN indicating a connection state (normal connection state, connection failure state, or the like) of the charging connector 31 to the ECU 27.

As a result, on the basis of the power management signal SPM, the ECU 27 of the power supply apparatus 20 draws the AC current toward the power supply apparatus 20 via the charging connector 31 and the charging inlet 21 so as not to exceed the allowable current value of the charging cable 32.

As a result, the bidirectional charger 22 converts the input AC power into DC power having a predetermined voltage and a predetermined current suitable for charging the in-vehicle battery 23 to charge the in-vehicle battery 23.

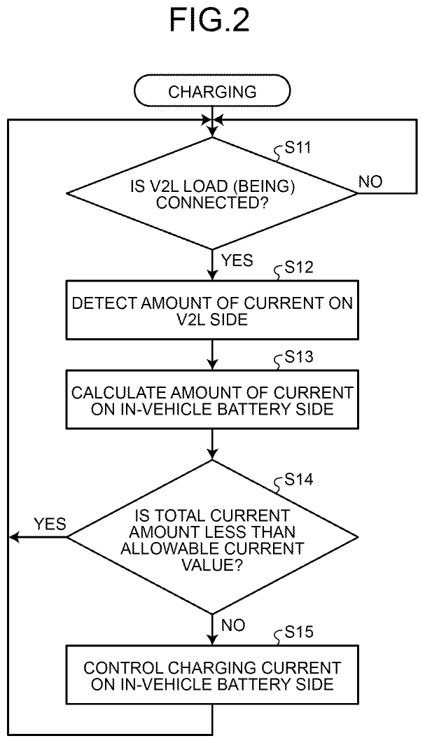

FIG. 2 is a processing flowchart of the first embodiment.

First, the current control unit 27X of the ECU 27 determines whether or not a load such as a home appliance is connected to the V2L outlet 26 (alternatively, whether or not the load is connected) (Step S11).

Note that, when a load is connected to the V2L outlet 26, a current flows rapidly for the first time, and thus, in order to prevent this, it is also possible to set a limit on the amount of current and gradually release the limit.

In this charged state, when a load such as a home appliance is connected to the V2L outlet 26, the circuit breaker 24 maintains the energized state unless overcurrent or overvoltage is detected.

Next, the current control unit 27X detects the current amount on the V2L side via the current sensor 25 (Step S12).

In addition, the current control unit 27X communicates with the bidirectional charger 22, and calculates the amount of current on the in-vehicle battery 23 side, which is the current to be supplied to the bidirectional charger 22 depending on the state of charge of the in-vehicle battery 23 at the time point (Step S13).

Then, the current control unit 27X determines whether or not it is assumed that the total current amount, which is the sum of the current amount on the V2L side and the current amount on the in-vehicle battery 23 side, is less than the allowable current value of the charging cable 32 (Step S14).

In the determination in Step S14, when it is assumed that the total current amount is less than the allowable current value of the charging cable 32 (Step S14; Yes), this means that there is no problem by continuing the charging and V2L power supply as it is, and thus, after the process proceeds to Step S11 again, the processes of Steps S11 to S14 are repeated at every predetermined timing.

When it is assumed in the determination in Step S14 that the total current amount is equal to or larger than the allowable current value of the charging cable 32 (Step S14; No), the charging and V2L power supply cannot be continued as it is, and the charging current on the in-vehicle battery 23 side whose current amount can be adjusted is controlled. Thus, the charging current control is performed by calculating the actual charging current on the in-vehicle battery 23 side to a value at which the total current amount is less than the allowable current value of the charging cable 32 (Step S15), the process again proceeds to Step S11, and thereafter, the processes of Steps S11 to S14 are repeated at every predetermined timing.

As described above, according to the first embodiment, it is not necessary to provide both the inverter and the charger, and thus the device configuration can be simplified. Further, it is possible to use the V2L outlet during charging of the in-vehicle battery while reducing the power conversion loss.

### Second Embodiment

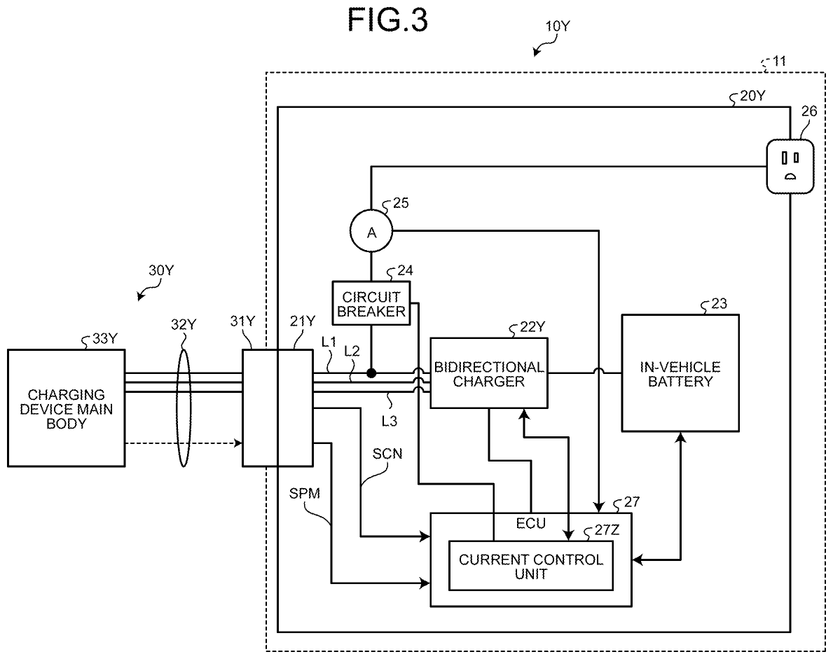

FIG. 3 is a schematic configuration block diagram of a power supply system including a power supply apparatus according to a second embodiment.

In FIG. 3, parts similar to those in FIG. 1 are denoted by the same reference numerals, and the detailed description thereof is incorporated.

As illustrated in FIG. 3, a power supply system 10Y of the second embodiment includes a power supply apparatus 20Y provided in the EV vehicle 11 and an external charging device 30Y.

The power supply apparatus 20Y includes a charging inlet 21Y compatible with three-phase alternating current, a bidirectional charger 22 compatible with three-phase AC, an in-vehicle battery 23, a circuit breaker 24, a current sensor 25, a V2L outlet 26, and an ECU 27.

Further, the external charging device 30Y includes a charging connector 31Y compatible with three-phase AC, a charging cable 32Y compatible with three-phase AC, and a charging device main body 33Y compatible with three-phase AC.

In the above configuration, the charging connector 31Y of the external charging device 30Y is electrically connected to the charging inlet 21Y at the time of charging by three-phase AC, and the charging power, which is three-phase AC power, and the power management signal SPM are input from the charging device main body 33Y via the charging connector 31Y and the charging cable 32Y.

Then, the charging inlet 21 outputs the input charging power to the bidirectional charger, and outputs the power management signal SPM to the ECU 27.

Further, the charging inlet 21 outputs the connection state signal SCN indicating a connection state (normal connection state, connection failure state, or the like) of the charging connector 31 to the ECU 27.

When the charging connector 31Y is connected to the charging inlet 21Y, a bidirectional charger 22Y converts the three-phase AC power from the charging inlet 21Y to charge the in-vehicle battery 23.

Further, when the charging connector 31Y is not connected to the charging inlet 21Y and the load is connected to the V2L outlet 26, the bidirectional charger 22Y converts the stored power of the in-vehicle battery 23 and supplies the converted power to the load.

When the external charging device 30Y supplies the three-phase AC 200 V as the three-phase AC power, only one of a first phase L1, a second phase L2, and a third phase L3 (in the example of FIG. 3, the first phase L1) is branched also toward the V2L, that is, the V2L outlet 26, and supplied via the circuit breaker 24.

In this case, the allowable current of the charging cable 32Y is the same in the first phase L1, the second phase L2, and the third phase L3, and each of which is, for example, 16 A (amperes).

Therefore, when the current of the first phase L1 is branched to the V2L outlet 26 side, a current control unit 27Z of the ECU 27 controls the L1 charging current so that the sum of the current flowing toward the bidirectional charger 22 (hereinafter, L1 charging current) and the current flowing toward the V2L outlet 26 (hereinafter, V2L current) does not exceed the allowable current.

In this case, when the sum of the V2L current and the L1 charging current reaches the allowable current of the charging cable 32, the ECU 27 sets the current of the second phase L2 flowing toward the bidirectional charger 22 to the L2 charging current, and when the current of the third phase L3 flowing toward the bidirectional charger 22 is set to the L3 charging current, if the L2 charging current and the L3 charging current are each less than the allowable current value of the charging cable 32, the current control unit 27Z increases the L2 charging current and the L3 charging current and supplies the required power of the in-vehicle battery 23 side.

Further, in order to improve the charging efficiency, when the required current on the in-vehicle battery 23 side can be supplied only with the L2 charging current and the L3 charging current, the L1 charging current is stopped and set to 0 (=the current of the first phase L1 is not used for charging), and the charging efficiency in the bidirectional charger 22 can be improved.

In addition, in order to reduce the influence on the system side, the current control unit 27Z of the ECU 27 preferably performs control so that pull-in currents of the first phase L1, the second phase L2, and the third phase L3 are the same.

In addition, for the phase (in the case of the above example, the first phase L1) in which the current branches toward the V2L outlet 26, in order to prevent the current from instantaneously exceeding the allowable current value, the current control unit 27Z of the ECU 27 once stops the current (in the case of the above example, the L1 charging current) flowing toward the bidirectional charger 22 and sets the current to 0 when the current starts to flow from the phase toward the V2L outlet 26.

Then, the current control unit 27Z of the ECU 27 confirms that the current toward the V2L outlet 26 is stabilized, and returns the current of the phase at a predetermined current value (for example, up to the allowable current value).

Next, the operation of the second embodiment will be described more specifically.

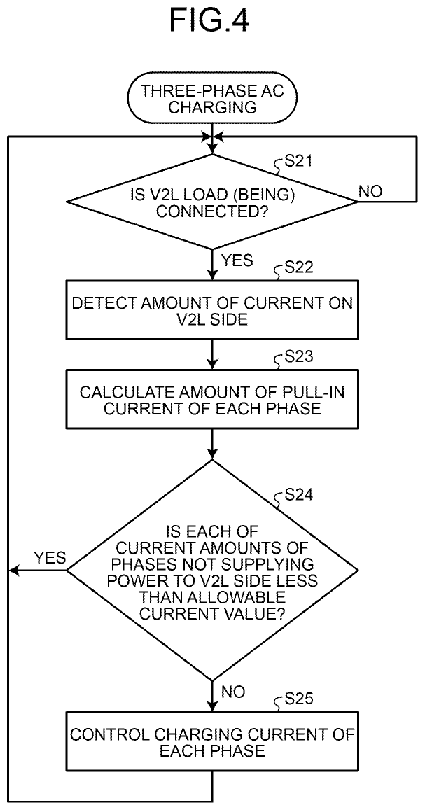

FIG. 4 is a processing flowchart of the second embodiment.

First, the current control unit 272 of the ECU 27 determines whether or not a load such as a home appliance is connected to the V2L outlet 26 (alternatively, whether or not the load is connected) (Step S21).

Note that, when a load is connected to the V2L outlet 26, a current flows rapidly for the first time, and thus, in order to prevent this, it is also possible to set a limit on the amount of current and gradually release the limit.

In the three-phase AC charged state, when a load such as a home appliance is connected to the V2L outlet 26, the circuit breaker 24 maintains the energized state unless overcurrent or overvoltage is detected.

Next, the current control unit 272 detects the current amount on the V2L side via the current sensor 25 (Step S22).

Further, the current control unit 27Z communicates with the bidirectional charger 22, and calculates the amount of current for each of the L1 charging current, the L2 charging current, and the L3 charging current on the in-vehicle battery 23 side, which are currents to be supplied to the bidirectional charger 22 depending on the state of charge of the in-vehicle battery 23 at that time (Step S23).

Then, the current control unit 27Z determines whether or not each of the current amounts of the phases not supplying current toward the V2L among the calculated current amounts is less than the allowable current value (Step S24).

That is, in the case of the above-described example, it is determined whether or not the current amounts of the L2 phase and the L3 phase, which are phases not supplying current to the V2L side, are each less than the allowable current value.

In the determination of Step S24, when the current amounts of the phases not supplying current toward the V2L are each less than the allowable current value (Step S24; Yes), this means that there is no problem by continuing the charging and V2L power supply as it is, and thus, after the process proceeds to Step S11 again, the processes of Steps S11 to S14 are repeated at every predetermined timing.

When it is assumed in the determination of Step S24 that the current amounts of the phases not supplying current toward the V2L are equal to or more than the allowable current value (Step S24; No), the charging and V2L power supply cannot be continued as they are, and thus the charging current of each phase is controlled so that the current amounts of all the phases become less than the allowable current value (Step S25).

Here, the control will be described more specifically.

In the following description, the allowable current of the charging cable 32Y is the same in the first phase L1, the second phase L2, and the third phase L3, and is, for example, 16 A (amperes) in each of them.

Therefore, when the current of the first phase L1 is branched toward the V2L outlet 26, the current control unit 27Z of the ECU 27 controls the L1 charging current so that the sum of the current flowing toward the bidirectional charger 22 (hereinafter, L1 charging current) and the current flowing toward the V2L outlet 26 (hereinafter, V2L current) does not exceed the allowable current.

In this case, when the sum of the V2L current and the L1 charging current reaches the allowable current of the charging cable 32, if the L2 charging current and the L3 charging current flowing toward the bidirectional charger 22 are each less than the allowable current value of the charging cable 32, the ECU 27 causes the current control unit 27Z to increase the L2 charging current and the L3 charging current and supplies the required power of the in-vehicle battery 23 side.

More specifically, for example, in a case where the current flowing through the first phase L1 is the current flowing toward the V2L=2 A in the initial state, the L1 charging current is 12 A, and the total is 14 A, when the current flowing through the second phase L2=L2 charging current=14 A, and the current flowing through the third phase L3=L3 charging current is 14 A in consideration of the load on the system, the second phase L2 and the third phase L3 are less than the allowable current value, and thus, from the viewpoint of improving the charging efficiency, the L2 charging current and the L3 charging current are set to the allowable current value, and the L1 charging current is reduced by that amount.

That is, in the case of the above example, the current flowing toward the V2L=2 A (no change), the L1 charging current is 8 A (=12 A−2 A−2 A) and the total is 10 A, and in consideration of the amount obtained by reducing the L1 charging current, the L2 charging current=16 A (=14 A+2 A) is set, and the L3 charging current is set to 16 A (=14 A+2 A).

Further, in order to improve the charging efficiency, when the required current on the in-vehicle battery 23 side can be supplied only with the L2 charging current and the L3 charging current, the L1 charging current is stopped and set to 0 (=the current of the first phase L1 is not used for charging), and the charging efficiency in the bidirectional charger 22 can be improved.

For example, in a case where charging is possible only with the L2 charging current=15 A and the L3 charging current=15 A, it is only necessary that the current flowing toward the V2L=2 A and the L1 charging current=0 A are set and the total is 2 A, the L2 charging current=15 A is set, and the L3 charging current=15 A is set.

In addition, in order to reduce the influence on the system side, the current control unit 272 of the ECU 27 preferably performs control so that the pull-in currents of the first phase L1, the second phase L2, and the third phase L3 are the same.

For example, in a case where the current flowing toward the V2L=6 A, the L1 charging current is 6 A, and the pull-in current of the first phase L1 is 12 A in total, the current flowing through the second phase L2=12 A is set, and the current flowing through the third phase L3=12 A is set in consideration of the load on the system.

In addition, for the phase (in the case of the above example, the first phase L1) in which the current branches toward the V2L outlet 26, in order to prevent the current from instantaneously exceeding the allowable current value, the current control unit 272 of the ECU 27 once stops the current (in the case of the above example, the L1 charging current) flowing toward the bidirectional charger 22 and sets the current to 0 when the current starts to flow from the phase toward the V2L outlet 26.

Then, the current control unit 272 of the ECU 27 confirms that the current to the V2L outlet 26 side is stabilized, and returns the current of the phase at a predetermined current value (for example, up to the allowable current value).

As described above, according to the second embodiment, it is not necessary to provide both the inverter and the charger in the case of supplying power using the three-phase AC, and thus the device configuration can be simplified. Further, it is possible to use the V2L outlet during charging of the in-vehicle battery while reducing the power conversion loss.

Furthermore, it is possible to improve the charging efficiency and reduce the influence on the system side.

According to the present disclosure, it is possible to reduce power loss and to expand an application range by reducing an installation area or an installation volume.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply apparatus comprising:
an inlet to which first AC power is input;
a bidirectional charger capable of performing power conversion between both AC power and DC power;
a battery that stores DC power;
a V2L outlet capable of outputting second AC power;
a current sensor that detects an amount of a current flowing toward the V2L outlet when the second AC power is output from the V2L outlet when the first AC power is branched and supplied to the bidirectional charger and the V2L outlet;
a memory; and
a hardware processor coupled to the memory, the hardware processor controlling an amount of a current flowing toward the bidirectional charger in such a manner that a total current amount of an amount of a current flowing toward the V2L outlet and an amount of a current flowing toward the bidirectional charger falls within a predetermined allowable current value.

2. The power supply apparatus according to claim 1, wherein
the first AC power is three-phase AC power,
any one of phases of the three-phase AC power is able to be branched and supplied to the V2L outlet and the bidirectional charger, and
other two phases are able to be supplied to the bidirectional charger.

3. The power supply apparatus according to claim 2, wherein
the hardware processor increases currents of the other two phases when the currents of the other two phases are less than a predetermined allowable current value, and reduces, by an increased amount of the currents, the current supplied to the bidirectional charger in the one phase.

4. The power supply apparatus according to claim 2, wherein
when a required power amount of the bidirectional charger is able to be covered by the other two phases, the hardware processor sets a current supplied to the bidirectional charger in the one phase to 0.

5. The power supply apparatus according to claim 2, wherein
the hardware processor sets a sum of amounts of currents branched and supplied to the V2L outlet and the bidirectional charger in the one phase and each of amounts of currents of the other two phases to be equal to each other.

6. The power supply apparatus according to claim 2, wherein
when the current starts flowing toward the V2L outlet in the one phase, the hardware processor once sets the current flowing toward the bidirectional charger to 0 and then gradually increases the current to an original value.

7. A method for controlling a power supply apparatus including an inlet to which first AC power is input, a bidirectional charger capable of performing power conversion between both AC power and DC power, a battery that stores DC power, a V2L outlet capable of outputting second AC power, a current sensor, a memory, and a hardware processor coupled to the memory, the method comprising:
detecting, by the current sensor, an amount of a current flowing toward the V2L outlet when the second AC power is output from the V2L outlet when the first AC power is branched and supplied to the bidirectional charger and the V2L outlet; and
controlling, by the hardware processor, an amount of a current flowing toward the bidirectional charger in such a manner that a total current amount of an amount of a current flowing toward the V2L outlet and an amount of a current flowing toward the bidirectional charger falls within a predetermined allowable current value.
